(19) United States
(12) Patent Application Publication
(10) Pub. No.: US 2026/0017260 A1
(43) Pub. Date: Jan. 15, 2026

(54) GATE NODE PROVIDING MOE SERVICE IN HYBRID PEER-TO-PEER NETWORK AND METHOD FOR OPERATING THE SAME

(71) Applicant: Electronics and Telecommunications Research Institute, Daejeon (KR)

(72) Inventor: Wook HYUN, Daejeon (KR)

(73) Assignee: Electronics and Telecommunications Research Institute, Daejeon (KR)

(21) Appl. No.: 19/265,443

(22) Filed: Jul. 10, 2025

(30) Foreign Application Priority Data
Jul. 12, 2024 (KR) 10-2024-0092565
May 28, 2025 (KR) 10-2025-0069892

(51) Int. Cl. G06F 16/2453

(52) U.S. Cl. CPC G06F 16/24542

(57) ABSTRACT

A gate node providing MoE service in a hybrid peer-to-peer network and its operating method are disclosed. A method of operation of the disclosed MoE gate node includes receiving a query from a user; determining at least one primary model to generate a response to the query from among a plurality of expert models connected to the MoE gate node; broadcasting the query to the at least one primary model; receiving a response broadcast from each of the at least one primary model; evaluating the response; and providing a final response generated based on the evaluation of the response to the user.

### CROSS-REFERENCE TO RELATED APPLICATIONS

This application claims the benefit of earlier filing date and right of priority to Korean Application No. 10-2024-0092565, filed on Jul. 12, 2024, Korean Application No. 10-2025-0069892, filed on May 28, 2025, the contents of which are all hereby incorporated by reference herein in their entirety.

### TECHNICAL FIELD

The following description describes a gate node and its operation method that provides MoE services in a hybrid peer-to-peer network.

### BACKGROUND

When implementing a Mixture of Experts (MoE) service in a distributed network, it is necessary to address the constraint of using a single Large Language Model (LLM) for all tasks, which can lead to knowledge gaps and potential inaccuracies. In addition, if a single LLM cannot cover all problems, hallucination issues can occur. To address these issues, the MoE model can be implemented by incorporating additional expert knowledge through fine-tuning, but it is difficult to add or replace expert models and support heterogeneous models. In addition, when operating a heterogeneous multi-vendor model in a distributed network, network quality issues and node failures can degrade service stability, which can cause certain expert functions to be disabled.

### SUMMARY

In one embodiment, utilizing HP2P networks for MoE services may provide numerous benefits and address key requirements of modern AI systems. HP2P networks allow for seamless integration of new expert models and nodes, allowing MoE services to scale efficiently as the number of expert models and users increases.

According to one embodiment, a Hybrid Peer-to-Peer (HP2P) communication service framework can be specified. Architecture, functions, and protocols for implementing efficient and scalable distributed services over an HP2P network can be defined.

However, technical challenges are not limited to the technical challenges described above, and other technical challenges may exist.

A method of operating a MoE gate node according to one embodiment of the present disclosure includes receiving a query from a user; determining at least one primary model to generate a response to the query from among a plurality of expert models connected to the MoE gate node; broadcasting the query to the at least one primary model; receiving a response broadcast from each of the at least one primary model; evaluating the response; and providing a final response generated based on the evaluation of the response to the user.

In addition, the determining at least one primary model may comprise determining the at least one primary model among the plurality of expert models based on the query and metadata of the plurality of expert models.

In addition, the determining at least one primary model may comprise: evaluating a output suitability of the plurality of expert models for an input data corresponding to the query through a gate model included in the MoE gate node; evaluating a relevance of the plurality of expert models for the query based on the metadata of the plurality of expert models through the meta model included in the MoE gate node; and determining the at least one primary model according to the output suitability and the relevance.

In addition, expert nodes including each of the multiple expert models may be connected to the MoE gate node through an overlay network.

In addition, the determining at least one primary model may comprise: determining a single primary model or a pluarlity of primary models based on at least one of a volume, complexity and uncertainty of input data corresponding to the query.

The operation method of the MoE gate node may further include receiving an evaluation of the response of the at least one primary model from a candidate model selected from among the plurality of expert models, and the evaluating the response may comprise evaluating the response considering an evaluation received from the candidate model.

In addition, the evaluating the response may comprise: evaluating the response of at least one primary model using the gate model included in the MoE gate node, and evaluating a reliability and quality of the response of the at least one primary model using a large language model (LLM) included in the MoE gate node.

In addition, the final response may be generated by a LLM included in the MoE gate node based on the responses of at least one primary model and an evaluation of a candidate model.

In addition, the final response may be based on an evaluation scores of a candidate model for the response of the at least one primary model, and is determined based on the responses of the at least one primary model and a modification suggestion of the candidate model.

In addition, a mixture of experts (MoE) gate node according to one embodiment of the present disclosure includes a processor; and a memory storing instructions, and the the instructions, when executed by the processor, cause the MoE gate node to: receive a query from a user; determine at least one primary model to generate a response to the query among a plurality of expert models connected to the above MoE gate node; broadcast the query to the at least one primary model; receive a response broadcast from each of the at least one primary model; evaluate the response; and provide a final response generated based on the evaluation of the response to the user.

In addition, the instructions, when executed by the processor, may cause the MoE gate node to determine a primary model among the plurality of expert models based on the query and metadata of the plurality of expert models.

In addition, the instructions, when executed by the processor, may cause the MoE gate node to: evaluate an output suitability of the plurality of expert models for an input data corresponding to the query through a gate model included in the MoE gate node; evaluate a relevance of the plurality of expert models for the query based on the metadata of the plurality of expert models through a meta model included in the MoE gate node; and determine the primary model according to the output suitability and the relevance.

In addition, expert nodes including each of the multiple expert models may be connected to the MoE gate node through an overlay network.

In addition, the instructions, when executed by the processor, may cause the MoE gate node to determine a single primary model or a plurality of primary models based on at least one of a volume, complexity and uncertainty of input data corresponding to the query.

In addition, the instructions, when executed by the processor, may cause the MoE gate node to: receive an evaluations of the responses of the at least one primary model from a candidate model selected from the plurality of expert models; and evaluate the responses by considering the evaluation received from the candidate model.

In addition, the instructions, when executed by the processor, may cause the MoE gate node to: evaluate the response of the at least one primary model using a gate model included in the MoE gate node; and evaluate a reliability and quality of the response of the at least one primary model using a large language model (LLM) included in the MoE gate node.

In addition, the final response may be generated by a LLM included in the MoE gate node based on the responses of at least one primary model and an evaluation of a candidate model.

In addition, the final response may be based on an evaluation scores of a candidate model for the response of the at least one primary model, and is determined based on the responses of the at least one primary model and a modification suggestion of the candidate model.

In one embodiment, the distributed nature of the HP2P network can improve the overall stability and availability of the MoE service by reducing single points of failure. The HP2P network can utilize resources from multiple nodes to more efficiently use computing power and storage, thereby enabling more complex and diverse expert models to be integrated into the system. The HP2P network can dynamically add and remove expert nodes, enabling the MoE service to quickly adapt to changing requirements and new areas of expertise.

Expert models can be distributed globally, reducing user latency across regions and providing access to a wider range of expertise. The HP2P architecture allows for shared learning experiences between expert models, potentially improving the overall knowledge base of the system. The distributed nature of the HP2P network provides better fault tolerance, ensuring continued service even if some nodes fail or become unavailable.

In one embodiment, the HP2P network can be designed to enhance data privacy by decentralizing sensitive information rather than centralizing it and allowing more granular control over data sharing. By leveraging resources across the peer network, HP2P can potentially reduce infrastructure costs associated with centralized systems.

According to one embodiment, the HP2P network can more easily integrate various expert models from various sources to enhance the overall functionality of the MoE service. Due to these advantages, the HP2P network is particularly suitable for the MoE service to implement a more robust, scalable, and adaptable Al system that can effectively utilize various expert knowledge.

### BRIEF DESCRIPTION OF THE DRAWINGS

FIG. 1 is a diagram for explaining a network structure according to one embodiment.

FIG. 2 is a diagram for explaining interactions between a gate node, an overlay management server, and multiple expert nodes according to one embodiment.

FIG. 3 is a flowchart for exemplarily explaining operations of a gate node, an overlay management server, and multiple expert nodes according to one embodiment.

FIG. 4 is a diagram for explaining an operation method of a MoE gate node according to one embodiment.

FIG. 5 is a diagram for explaining an electronic device according to one embodiment.

### DETAILED DESCRIPTION

Specific structural or functional descriptions of the embodiments are disclosed for illustrative purposes only and may be implemented in various forms. Therefore, the actual implemented form is not limited to the specific embodiments disclosed, and the scope of the present disclosure includes modifications, equivalents, or alternatives included in the technical idea described in the embodiments.

In this document, the phrases “A or B”, “at least one of A and B”, “at least one of A or B”, “A, B, or C”, “at least one of A, B, and C”, “at least one of A, B, or C”, and “a combination of one or more of A, B, and C” can each include any one of the items listed together in that phrase, or all possible combinations thereof. Although the terms first or second, etc. may be used to describe various components, such terms should be construed only to distinguish one component from another. For example, a first component may be referred to as a second component, and similarly, a second component may also be referred to as a first component.

When it is said that a component is “connected” to another component, it should be understood that it may be directly connected or connected to that other component, but there may also be other components present in between.

Singular expressions include plural expressions unless the context clearly indicates otherwise. In this specification, the terms “comprises” or “have” should be understood to specify the presence of a described feature, number, step, operation, component, part, or combination thereof, but do not exclude the possibility of the presence or addition of one or more other features, numbers, steps, operations, components, parts, or combinations thereof.

Unless otherwise defined, all terms used herein, including technical or scientific terms, have the same meaning as commonly understood by one of ordinary skill in the art. Terms defined in commonly used dictionaries should be interpreted as having a meaning consistent with the meaning they have in the context of the relevant art, and will not be interpreted in an idealized or overly formal sense unless explicitly defined herein.

Hereinafter, embodiments will be described in detail with reference to the attached drawings. When describing with reference to the attached drawings, identical components are given the same reference numerals regardless of the drawing

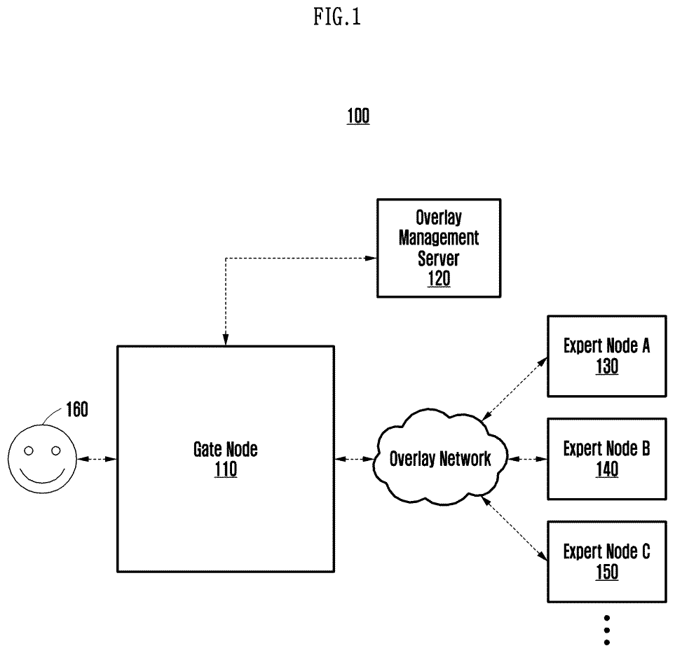

FIG. 1 is a diagram for explaining a network structure according to one embodiment.

Referring to FIG. 1, a network (100) in which a gate node (110), an overlay management server (120), and multiple expert nodes (130 to 150) are connected is exemplarily illustrated. The network (100) may be implemented as an overlay network.

By implementing MoE services in a distributed network, hallucination issues that occur due to the use of a single LLM that cannot solve all problems can be effectively suppressed. Furthermore, MoE services via HOSF can support both homogeneous and heterogeneous model integration by utilizing a dynamic system that can add and remove LLMs within the network. This flexibility enables the integration of models from different suppliers and different specializations. This system facilitates the sharing of query-response data between participating models, which can improve future performance.

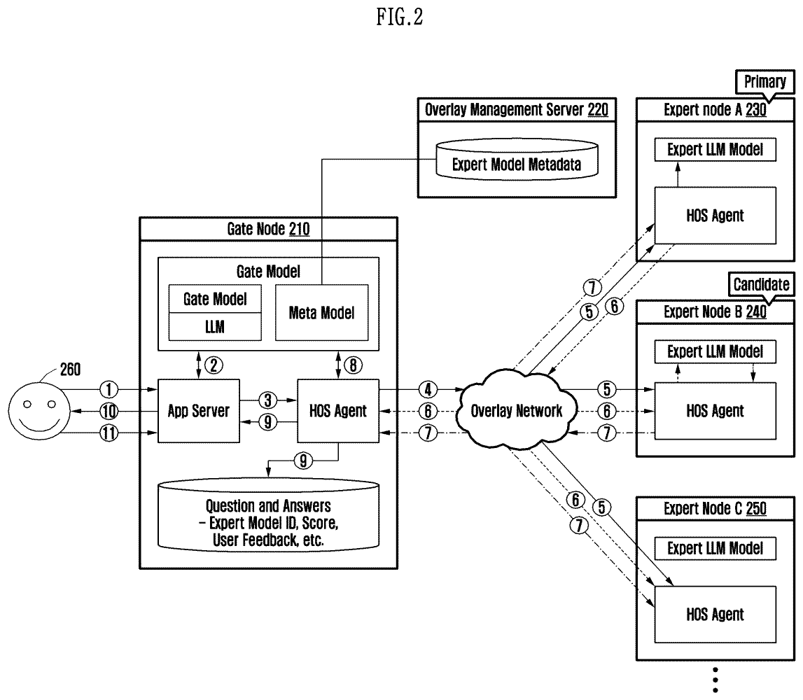

The gate node (110) may be a central component of the MoE system that evaluates the expertise of various expert nodes (130 to 150) and directs (or forward) the user's (160) query to the most appropriate expert node. The gate node (110) may operate in a hybrid manner utilizing three models: a meta model, a gate model, and an LLM, which will be described in detail with reference to FIG. 2. In this specification, for convenience of explanation, the gate node (110) may also be referred to as an MoE gate node.

Each of the plurality of expert nodes (130 to 150) may be a specialized component within the MoE system trained on specific domain knowledge. These expert nodes may provide expert responses to queries delivered from the gate node (110). Each expert node operates independently and may provide specialized knowledge to the entire system.

The overlay management server (120) may manage the overlay network within the MoE system. The overlay management server (120) may maintain information on all participating expert nodes of the network. The overlay management server (120) may play an important role in the system configuration and may ensure efficient communication between various components of the MoE network. In this specification, for convenience of explanation, the overlay management server (120) may also be referred to as a Hybrid Overlay Management Server (HOMS).

An overlay network is another network built on top of an existing network, and is a virtual network built by configuring separate nodes and logical links on top of the existing network. Such an overlay network may provide more efficient network services by increasing scalability by utilizing the existing network. Depending on the implementation method, an overlay network can be divided into a mesh-based overlay network and a tree-based overlay network.

Mesh-based overlay networks may quickly transmit and receive large files in a non-real-time manner, but may be somewhat unsuitable for real-time data transmission. In other words, mesh-based overlay networks can increase stability and scalability, but may be unsuitable for real-time live services.

In a tree-based overlay network, a method may be used in which one or a small number of source terminals transmit data in a relay form to a large number of receiving terminals. A tree-based overlay network may transmit real-time data quickly, but it is difficult to configure and maintain the tree, and if a node in the middle of the tree is removed or fails, data may not be transmitted to a large number of nodes connected to that node.

To overcome these shortcomings, a hybrid overlay network that combines a tree-based overlay network and a mesh-based overlay network can be utilized.

According to one embodiment, a hybrid overlay network may represent a node-to-node overlay network in which participating nodes exchange data in a pull and push method. In other words, the hybrid overlay network may organize and maintain a tree-style path that can push data to all nodes without loops and simultaneously fetch data from other nodes. The hybrid overlay network may include a distributed overlay network. In this specification, for convenience of explanation, the hybrid overlay network may be referred to as an overlay network or an overlay.

A hybrid overlay network may be a network that combines a tree-based overlay network with a mesh-based overlay network. Various services may be provided in a hybrid overlay network. It may be important to know which service the data transmitted through the hybrid overlay network corresponds to and how the detailed data transmission configured to provide each service is configured. In addition, control over users who can access the service and users who have data transmission authority may also be important.

HOS (hybrid overlay service) may be based on a HP2P (hybrid peer to peer) network. The HP2P network may distribute real-time data to multiple nodes and provide a distributed service network required for video conferencing, blockchain, broadcasting, games, etc.

In this specification, for convenience of explanation, a node may also be referred to as a model. In addition, a message transmitted between nodes may be a request or a response, and a request may include a query, and a response may include an answer or an evaluation.

FIG. 2 is a diagram illustrating interactions between a gate node, an overlay management server, and multiple expert nodes according to one embodiment.

Referring to FIG. 2, a message flow for explaining the interaction between a gate node (210), an overlay management server (220), and multiple expert nodes (230 to 250) may be expressed by numbers within a circle in FIG. 2. In the service scenario below, a node may mean an application of a MoE service, not a machine.

The gate node (210) is a central component of the MoE system that evaluates the expertise of various nodes and directs (or forwards) a user query to the most appropriate expert node, and may operate in a hybrid manner utilizing three models: a meta model, a gate model, and an LLM. The meta model may evaluate the expertise of each node, calculate an expertise score, and rank expert models. The gate model may analyze the output of the expert model based on the node expert model information, and the fine-tuned gate model may determine the expertise by understanding the contextual relationships. The gate node (210) may generate a final response to the user based on the input received from the expert model using the LLM. For example, the meta model may be a conceptual model such as a database, not an artificial intellectual model.

The plurality of expert nodes (230 to 250) may be specialized components within the MoE system trained on specific domain knowledge. It may be assumed that the LLM included in each of the plurality of expert nodes (230 to 250) already possesses significant linguistic knowledge and general information acquired through training on a large data set. In addition, it may be assumed that each of the plurality of expert nodes (230 to 250) is a derivative model of this base LLM and has been fine-tuned with additional expert data to enhance expertise on a specific domain.

The overlay management server (220) may manage the overlay network within the MoE system. The overlay management server (220) may maintain information on all participating expert nodes in the network. The overlay management server (220) plays an important role in the system configuration and may ensure efficient communication between various components of the MoE network.

First, the alliance phase may proceed as follows.

The gate node (210) may create and join an overlay network, initiate processes, and serve as a central point for managing and coordinating activities within the network. Each of the plurality of expert nodes (230 to 250) may join an overlay network created by the gate node (210). A single expert node corresponding to each of the plurality of expert nodes (230 to 250) may participate in multiple overlay networks if separate peers are operated for each network. When joining an overlay network, each expert node may provide detailed information about the special data used for training to the gate node (210). The information provided by each expert node may include metadata about the specialty of the LLM included in each expert node, the training data, and the performance metrics. In addition, the information provided may include an explicit specification of the base model used for fine tuning and a comprehensive description of the information used for training. The gate node (210) may utilize the information provided by each expert node to identify an expert model suitable for future queries. This alliance process can facilitate efficient query routing and response generation by ensuring proper integration and effective utilization of expert nodes within the MoE system.

Next, the querying phase can proceed as follows.

HP2P-based MoE services may process user queries and generate responses using two primary operational modes. These modes may be designed to optimize the utilization of expert knowledge in a distributed network while maintaining efficiency and accuracy in response generation.

In mode 1, multiple expert model utilization may be performed. In the multiple expert model utilization mode, multiple expert nodes may be utilized simultaneously. The gate node (210) may distribute the user's query to multiple primary nodes (e.g., expert node A (230) of FIG. 2) and request the candidate node (e.g., expert node B (240) of FIG. 2) to evaluate the answer of the primary node. Since all requests, answers, and evaluations are distributed in the hybrid P2P network, each message can be automatically shared by all nodes. This approach can be utilized when various viewpoints and approaches are required for richer and more creative responses, or when the LLM of the gate node (210) lacks confidence in the answer evaluation. The gate node (210) may comprehensively evaluate the answer and evaluation of each expert node to determine the final answer for the user (260).

In mode 2, single expert model utilization may be performed. The single expert model utilization mode may select a single primary node to provide an answer. Other expert nodes designated as candidate nodes may evaluate the answer of the primary node and provide an evaluation including a correction suggestion if appropriate. This method may be suitable for simple queries where a single expert answer is sufficient. The gate node (210) may combine the answer of the primary node and the evaluation of the candidate node to generate a final response.

The system described herein may utilize user feedback for continuous training and improvement in two modes. The performance of each expert node may be consistently evaluated, and the meta-model within the gate node (210) may be updated accordingly. Through this mechanism, the system may provide increasingly accurate and efficient responses over time, flexibly handle queries of varying complexity, and optimally utilize expert knowledge in the HP2P network.

Finally, the optimizing phase may proceed as follows.

HP2P-based MoE services may incorporate mechanisms for continuous improvement through data set building and additional learning. These processes can enhance the system's ability to handle diverse queries and improve intelligence.

In connection with the construction of the dataset, the system may continuously accumulate a list of queries and answers shared in the mesh-style overlay network. This approach allows collecting advanced data on various queries, which can be used for further learning and intelligence improvement. The dataset may include user queries and final answers. The final answer may include the response of each primary node, evaluation scores using the gated model, evaluation scores of other nodes, and user feedback. A separate LLM process may filter out potentially problematic content from the collected query-response dataset, thereby maintaining data quality and compliance.

With respect to additional learning, the system may apply an additional learning mechanism to improve the performance, mainly through continuous learning of the gate models within the gate nodes (210). The gate nodes (210) may utilize the collected data to fine-tune the gate models and update information on which expert models excel in a specific domain(s). The gate model may undergo reinforcement learning to assess each model's expertise, rewarding correct predictions and penalizing incorrect predictions. This process may gradually improve the ability of the gate nodes (210) to select the model that best suits the input data. The gate nodes (210) may continuously track the performance of the LLMs within each expert node and learn to favor LLMs with good performance and exclude LLMs with poor performance.

Through this learning process, HP2P-based MoE services may adapt to changing query patterns, improve their expertise assessment capabilities, and maintain high-quality responses over time.

According to the embodiment illustrated in FIG. 2, in operation (1), a user (260) may input a query to a gate node (210). The user (260) may submit the query to an app server of the gate node (210). The system may assign (or allocate) an identifier to the user query, and the gate node (210) may cache a message with the identifier for future reference. This message may include the query, answers, and evaluations of all participating nodes.

In operation (2), the app server in the gate node (210) can transmit a query input by a user to the gate model. For example, the gate model may designate a primary node among a plurality of expert nodes (230 to 250) based on the query. According to an embodiment, the gate model may also designate a candidate node among a plurality of expert nodes (230 to 250) based on the query.

For example, when receiving a user's query, the gate node (210) may apply the gate model and the meta model to determine the most suitable expert model to process the query. The gate model may learn which model performs well with specific input data and evaluate the output suitability of each model. The meta model can utilize the metadata registered by each expert node to select the most relevant model and maintain scores for the accuracy, performance, reliability, and response speed of each expert node.

In operation (3), the app server forwards a query to the HOS Agent, and in operations (4 and 5), the HOS Agent may broadcast the query to multiple expert nodes (230 to 250) through the overlay network.

For example, a gate node (210) may broadcast a query to selected expert nodes in the overlay network. The gate node (210) may determine whether to designate a single expert node or multiple nodes based on various parameters such as the length, complexity, ambiguity, etc. of the query. This process may proceed in one of two modes. Mode 1 may involve concurrent requests to multiple primary models and evaluation of candidate models. In contrast, Mode 2 may select a single expert model for response.

In operation (6), expert node A (230), which corresponds to the primary node, may generate an answer to the query and transmit it to the gate node (210) and other expert nodes (240 and 250) through the overlay network.

For example, designated expert nodes (e.g., primary nodes and candidate nodes) may generate responses, such as answers and evaluations, and broadcast them to the overlay network. In mode 1, primary nodes may generate individual answers, while candidate nodes may evaluate these responses and provide scores. In mode 2, designated primary nodes may generate answers, while candidate nodes may provide evaluations, if designated.

In operation (7), expert node B (240) corresponding to the candidate node may generate an evaluation of the primary node's answer and transmit it to the gate node (210) and other expert nodes (230 and 250) through the overlay network.

The gate node (210) may evaluate the answers received from each node. In mode 1, the gate node (210) may evaluate each answer using the gate model, integrate the scores from the candidate nodes, and evaluate the reliability and quality using the LLM. In mode 2, the gate node (210) may calculate the scores for the responses of the primary node and the feedback of the candidate nodes.

In operation (8), the HOS Agent may transmit the answer of the primary node and the evaluation of the candidate node received through the overlay network to the gate model. The gate model may comprehensively evaluate the answer of the primary node and the evaluation of the candidate node to determine a final answer for the user (260) and transmit it to the HOS Agent. In operation (9), the HOS Agent may store the answer of the primary node, the evaluation of the candidate node, the comprehensive evaluation of the gate model, and the final answer in a database, and transmit the final answer to the app server. In operation (10), the app server can provide the final answer to the user (260).

The gate node (210) may generate a final response based on the received message and deliver it to the user. In mode 1, the system may synthesize the final answer using LLM by considering the responses from the primary node and the candidate nodes. In mode 2, the action of the system depends on the average score from the candidate nodes, and may potentially combine the response from the primary node and the modification suggestions from the candidate nodes.

In operation (11), the app server may receive feedback from the user (260). The feedback may be utilized for learning the gate model.

For example, when multiple options are presented, the user (260) may select the most satisfactory response. This selection can be fed back to the gate node (210), recorded in the query-response dataset, and reflected in the meta model. Through this process, the system can update its preference for knowledge domains where the new model shows higher performance.

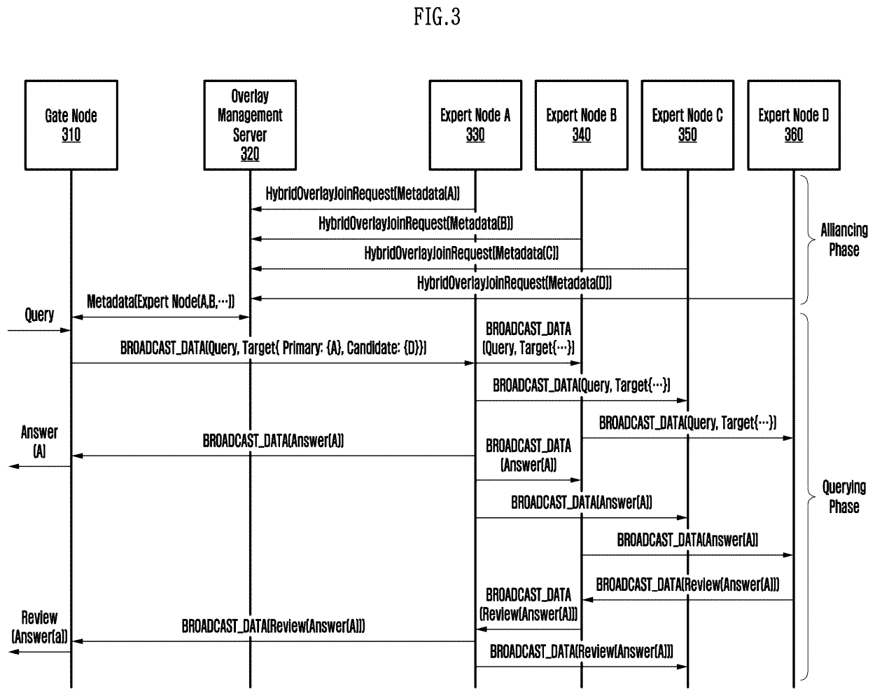

FIG. 3 is a flowchart for exemplarily explaining the operations of a gate node, an overlay management server, and multiple expert nodes according to one embodiment.

Referring to FIG. 3, an example of an alliance phase and a querying phase can be illustrated as a flowchart.

In the alliancing phase, multiple expert nodes (330 to 360) may transmit a hybrid overlay participation request message to the overlay management server (320). The message may include metadata for each expert node. The overlay management server (320) may transmit the metadata included in the received message to the gate node (310) so that metadata for expert nodes wishing to participate can be registered in the gate node (310).

In the querying phase, the gate node (310) may receive a query from a user and broadcast the query to a plurality of expert nodes (330 to 360) using broadcast data. The broadcast data may include information about target nodes including primary nodes and/or candidate nodes as well as the query. An expert node A (330) designated as a primary node may generate an answer to the query and broadcast it to the gate node (310) and other expert nodes (340 to 360). An expert node D (360) designated as a candidate node may generate an evaluation of the answer and broadcast it to the gate node (310) and other expert nodes (330, 350, 360). The gate node (310) may comprehensively evaluate the answer of the primary node and the evaluation of the candidate nodes and provide the generated final answer to the user.

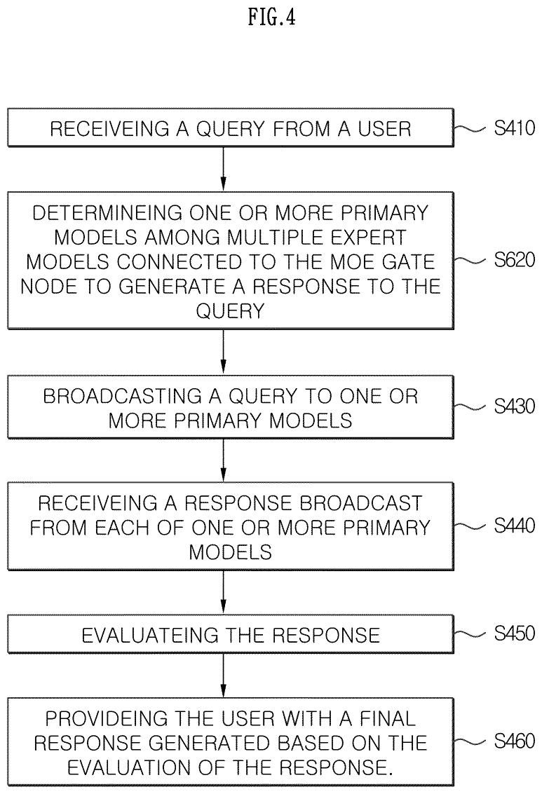

FIG. 4 is a diagram illustrating an operation method of a MoE gate node according to one embodiment.

In the following embodiments, the operations may be performed sequentially, but are not necessarily performed sequentially. For example, the order of the operations may be changed, and at least two operations may be performed in parallel. Operations (410) to (450) may be performed by at least one component (e.g., processor, etc.) of the electronic device.

In operation (410), the MoE gate node receives a query from a user.

In operation (420), the MoE gate node determines one or more primary models among multiple expert models connected to the MoE gate node to generate a response to the query.

The MoE gate node may determine a primary model among multiple expert models based on a query and metadata of multiple expert models.

The MoE gate node may evaluate the output suitability of multiple expert models for input data corresponding to a query through a gate model included in the MoE gate node, and may evaluate the relevance of multiple expert models for a query based on metadata of the multiple expert models through a meta model included in the MoE gate node, and determine a primary model based on the output suitability and relevance.

The MoE gate node may determine a single primary model or multiple primary models based on at least one of the volume, complexity, and uncertainty of input data corresponding to the query.

In operation (430), the MoE gate node broadcasts a query to one or more primary models.

Expert nodes, each of which includes multiple expert models, may be connected to the MoE gate node in an overlay network.

In operation (440), the MoE gate node receives a response broadcast from each of one or more primary models.

In operation (450), the MoE gate node evaluates the response.

The MoE gate node may receive evaluations of responses of one or more primary models from candidate models selected from among multiple expert models, and evaluate the responses by further considering the evaluations received from the candidate models.

The MoE gate node may evaluate the responses of one or more primary models using the gate model included in the MoE gate node, and may evaluate the reliability and quality of the responses of one or more primary models using the LLM included in the MoE gate node.

In operation (460), the MoE gate node provides the user with a final response generated based on the evaluation of the response.

The final response may be generated by the LLM included in the MoE gate node based on the responses of one or more primary models and the evaluation of the candidate models.

The final response depends on the evaluation scores of the candidate model against the responses of one or more primary models, and can be determined based on the responses of one or more primary models and the modification suggestions of the candidate model.

Since the matters described above through FIGS. 1 to 3 are applied to each step illustrated in FIG. 4, a more detailed description is omitted.

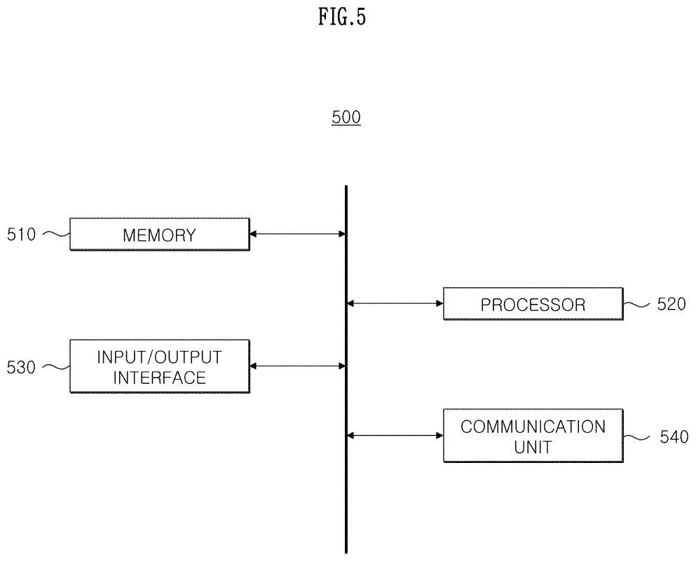

FIG. 5 is a drawing showing an electronic device according to one embodiment.

Referring to FIG. 5, an electronic device (500) according to one embodiment may include a memory (510), a processor (520), an input/output interface (530), and a communication unit (540), which may communicate with each other through a communication bus. For example, the electronic device (500) may be implemented as any one of a gate node, an overlay management server, and an expert node. For example, the electronic device (500) may be an electronic device implemented as at least a part of a mobile device such as a mobile phone, a smart phone, a PDA, a netbook, a tablet computer, a laptop computer, a wearable device such as a smart watch, a smart band, a smart glasses, a computing device such as a desktop, a server, a home appliance such as a television, a smart television, a refrigerator, a security device such as a door lock, and a vehicle such as an autonomous vehicle, a smart vehicle, and the like.

The processor (520) executes functions and instructions to be executed within the electronic device (500). For example, the processor (520) may process instructions stored in the memory (510). The processor (520) may perform one or more operations described with reference to FIGS. 1 to 4. The memory (510) may include a computer-readable storage medium or a computer-readable storage device. The memory (510) may store instructions to be executed by the processor (520) and may store related information while software and/or applications are executed by the electronic device (500).

The input/output interface (550) can receive input from a user via traditional input methods such as a keyboard and mouse, and new input methods such as touch input, voice input, and image input. For example, the input/output interface (550) can include a keyboard, a mouse, a touch screen, a microphone, or any other device that can detect input from a user and transmit the detected input to the electronic device (500). In addition, the input/output interface (550) can provide output of the electronic device (500) to the user via visual, auditory, or tactile channels. The input/output interface (550) can include, for example, a display, a touch screen, a speaker, a vibration generating device, or any other device that can provide output to the user.

The communication unit (540) can communicate with an external device (e.g., another electronic device) via a wired or wireless network.

In addition, the above-described operation can be processed with respect to the electronic device (500).

The embodiments described above may be implemented as hardware components, software components, and/or a combination of hardware components and software components. For example, the devices, methods, and components described in the embodiments may be implemented using a general-purpose computer or a special-purpose computer, such as, for example, a processor, a controller, an arithmetic logic unit (ALU), a digital signal processor, a microcomputer, a field programmable gate array (FPGA), a programmable logic unit (PLU), a microprocessor, or any other device capable of executing instructions and responding to them. The processing device may execute an operating system (OS) and software applications running on the OS. In addition, the processing device may access, store, manipulate, process, and generate data in response to the execution of the software. For ease of understanding, the processing device is sometimes described as being used alone, but those skilled in the art will appreciate that the processing device may include multiple processing elements and/or multiple types of processing elements. For example, a processing device may include multiple processors, or a processor and a controller. Other processing configurations, such as parallel processors, are also possible.

The software may include a computer program, code, instructions, or a combination of one or more of these, which may configure a processing device to perform a desired operation or may independently or collectively command the processing device. The software and/or data may be stored on any type of machine, component, physical device, virtual equipment, computer storage medium, or device for interpretation by the processing device or for providing instructions or data to the processing device. The software may also be distributed over network-connected computer systems and stored or executed in a distributed manner. The software and data may be stored on a computer-readable recording medium.

The method according to the embodiment may be implemented in the form of a program command that can be executed through various computer means and recorded on a computer-readable medium. The computer-readable medium may store program commands, data files, data structures, etc., alone or in combination, and the program commands recorded on the medium may be those specially designed and configured for the embodiment or may be those known to and usable by those skilled in the art of computer software. Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program commands such as ROMs, RAMs, and flash memories. Examples of the program commands include not only machine language codes generated by a compiler, but also high-level language codes that can be executed by a computer using an interpreter, etc.

The hardware device described above may be configured to operate as one or more software modules to perform the operations of the embodiment, and vice versa.

Although the embodiments have been described with limited drawings as described above, those skilled in the art can apply various technical modifications and variations based on the described embodiments. For example, appropriate results can be achieved even if the described techniques are performed in a different order than the described method, and/or components of the described system, structure, device, circuit, etc. are combined or combined in a different form than the described method, or are replaced or substituted by other components or equivalents.

Therefore, other implementations, other embodiments, and equivalents to the claims are also included in the scope of the claims described below.

1. A method of operation of a mixture of experts (MoE) gate node, the method comprising:
receiving a query from a user;
determining at least one primary model to generate a response to the query from among a plurality of expert models connected to the MoE gate node;
broadcasting the query to the at least one primary model;
receiving a response broadcast from each of the at least one primary model;
evaluating the response; and
providing a final response generated based on the evaluation of the response to the user.

2. The method of claim 1, wherein:
the determining at least one primary model comprises:
determining the at least one primary model among the plurality of expert models based on the query and metadata of the plurality of expert models.

3. The method of claim 2, wherein:
the determining at least one primary model comprises:
evaluating an output suitability of the plurality of expert models for an input data corresponding to the query through a gate model included in the MoE gate node;
evaluating a relevance of the plurality of expert models for the query based on the metadata of the plurality of expert models through a meta model included in the MoE gate node; and
determining the at least one primary model according to the output suitability and the relevance.

4. The method of claim 1, wherein:
expert nodes including each of the multiple expert models are connected to the MoE gate node through an overlay network.

5. The method of claim 1, wherein:
the determining at least one primary model comprises:
determining a single primary model or a pluarlity of primary models based on at least one of a volume, complexity and uncertainty of input data corresponding to the query.

6. The method of claim 1, further comprising:
receiving an evaluation of the response of the at least one primary model from a candidate model selected from among the plurality of expert models, and
wherein the evaluating the response comprises:
evaluating the response considering the evaluation received from the candidate model.

7. The method of claim 6, wherein the evaluating the response comprises:
evaluating the response of at least one primary model using a gate model included in the MoE gate node, and
evaluating a reliability and quality of the response of the at least one primary model using a large language model (LLM) included in the MoE gate node.

8. The method of claim 1, wherein:
the final response is generated by a LLM included in the MoE gate node based on the responses of at least one primary model and an evaluation of a candidate model.

9. The method of claim 1, wherein:
the final response is based on an evaluation scores of a candidate model for the response of the at least one primary model, and is determined based on the responses of the at least one primary model and a modification suggestion of the candidate model.

10. A non-transitory computer-readable recording medium storing instructions that, when executed by one or more processors, configure the one or more processors to perform the method of claim 1.

11. A mixture of experts (MoE) gate node comprising:
a processor; and
a memory storing instructions,
wherein the instructions, when executed by the processor, cause the MoE gate node to: receive a query from a user;
determine at least one primary model to generate a response to the query among a plurality of expert models connected to the MoE gate node;
broadcast the query to the at least one primary model;
receive a response broadcast from each of the at least one primary model;
evaluate the response; and
provide a final response generated based on the evaluation of the response to the user.

12. The Moe gate node of claim 11, wherein:
the instructions, when executed by the processor, cause the MoE gate node to determine a primary model among the plurality of expert models based on the query and metadata of the plurality of expert models.

13. The Moe gate node of claim 12, wherein:
the instructions, when executed by the processor, cause the MoE gate node to:
evaluate an output suitability of the plurality of expert models for an input data corresponding to the query through a gate model included in the MoE gate node;
evaluate a relevance of the plurality of expert models for the query based on the metadata of the plurality of expert models through a meta model included in the MoE gate node; and
determine the primary model according to the output suitability and the relevance.

14. The Moe gate node of claim 11, wherein:
expert nodes including each of the multiple expert models are connected to the MoE gate node through an overlay network.

15. The Moe gate node of claim 11, wherein:
the instructions, when executed by the processor, cause the MoE gate node to determine a single primary model or a plurality of primary models based on at least one of a volume, complexity and uncertainty of input data corresponding to the query.

16. The Moe gate node of claim 11, wherein:
the instructions, when executed by the processor, cause the MoE gate node to:
receive an evaluations of the responses of the at least one primary model from a candidate model selected from the plurality of expert models; and
evaluate the responses by considering the evaluation received from the candidate model.

17. The Moe gate node of claim 16, wherein:
the instructions, when executed by the processor, cause the MoE gate node to:
evaluate the response of the at least one primary model using a gate model included in the MoE gate node; and
evaluate a reliability and quality of the response of the at least one primary model using a large language model (LLM) included in the MoE gate node.

18. The Moe gate node of claim 11, wherein:
the final response is generated by a LLM included in the MoE gate node based on the responses of at least one primary model and an evaluation of a candidate model.

19. The Moe gate node of claim 11, wherein:
the final response is based on an evaluation scores of a candidate model for the response of the at least one primary model, and is determined based on the responses of the at least one primary model and a modification suggestion of the candidate model.
